(19) United States
(12) Patent Application Publication
(10) Pub. No.: US 2016/0026759 A1
(43) Pub. Date: Jan. 28, 2016

(54) Detecting Chromosomal Aneuploidy

(71) Applicant: Yourgene Bioscience, New Taipei City (TW)

(72) Inventor: Chia-Han CHAN, New Taipei City (TW)

(21) Appl. No.: 14/636,193

(22) Filed: Mar. 3, 2015

Related U.S. Application Data
(60) Provisional application No. 62/027,258, filed on Jul. 22, 2014.

(51) Int. Cl. G06F 19/22

(52) U.S. Cl. CPC G06F 19/22

(57) ABSTRACT

A method for detecting a chromosomal aneuploidy relating to a target nucleic acid region includes the following steps. A reference database is obtained. At least one normalizing factor is determined based on the reference database. A cutoff value is determined based on the reference database. A biological sample under test is sequenced by the sequencing platform to obtain a number of target reads of the biological sample under test. The target reads of the biological sample under test originate from the target nucleic acid region. The number of the target reads of the biological sample under test is normalized by the normalizing factor and then is compared with the cutoff value. Whether the chromosomal aneuploidy relating to the target nucleic acid region is present in the fetus is determined based on the comparison

This application claims priority to U.S. Provisional Application Ser. No. 62/027,258, filed Jul. 22, 2014, which is herein incorporated by reference.

### BACKGROUND

1. Technical Field

The present disclosure relates to bioinformatics.

2. Description of Related Art

Aneuploidy is a condition in which the chromosome number is not an exact multiple of the number characteristic of a particular species. An extra or missing chromosome is a common cause of genetic disorders including human birth defects. Amniocentesis (also referred to as amniotic fluid test or AFT) is a medical procedure used in prenatal diagnosis of chromosomal abnormalities and fetal infections. The most common abnormalities detected are Down syndrome (trisomy 21), Edwards syndrome (trisomy 18), Patau syndrome (trisomy 13) and Turner syndrome (monosomy X). However, amniocentesis carries various risks, including miscarriage, needle injury, leaking amniotic fluid, Rh sensitization, infection, and infection transmission.

### SUMMARY

According to some embodiments of the present invention, a method for detecting a chromosomal aneuploidy relating to a target nucleic acid region includes the following steps. A reference database is obtained. The reference database is established by sequencing a plurality of reference biological samples by a sequencing platform. At least one normalizing factor is determined based on the reference database. A cutoff value is determined based on the reference database. A biological sample under test is sequenced by the sequencing platform to obtain a number of target reads of the biological sample under test. The biological sample under test is obtained from a pregnant female and has nucleic acid molecules from the pregnant female and a fetus thereof. The target reads of the biological sample under test originate from the target nucleic acid region. The number of the target reads of the biological sample under test is normalized by the normalizing factor. The normalized number of the target reads of the biological sample under test is compared with the cutoff value. Whether the chromosomal aneuploidy relating to the target nucleic acid region is present in the fetus is determined based on the comparison.

According to some embodiments of the present invention, a non-transitory machine readable medium stores a program which, when executed by at least one processing unit, detects a chromosomal aneuploidy relating to a target nucleic acid region. The program includes sets of instructions for the following steps. A reference database is obtained. The reference database is established by sequencing a plurality of reference biological samples by a sequencing platform. At least one normalizing factor is determined based on the reference database. A cutoff value is determined based on the reference database. A biological sample under test is sequenced by the sequencing platform to obtain a number of target reads of the biological sample under test. The biological sample under test is obtained from a pregnant female and has nucleic acid molecules from the pregnant female and a fetus thereof. The target reads of the biological sample under test originate from the target nucleic acid region. The number of the target reads of the biological sample under test is normalized by the normalizing factor. The normalized number of the target reads of the biological sample under test is compared with the cutoff value. Whether the chromosomal aneuploidy relating to the target nucleic acid region is present in the fetus is determined based on the comparison.

### BRIEF DESCRIPTION OF THE DRAWINGS

FIG. 1 is a flowchart of a method for detecting a chromosomal aneuploidy according to some embodiments of the present invention.

FIGS. 2A and 2B show plots of chromosome reads of a plurality of reference biological samples sequenced by the same sequencing platform according to a plurality of working examples of the present invention.

FIG. 3 is a flowchart of the step 120 of FIG. 1.

FIG. 4 is a flowchart of the step 123 of FIG. 3.

FIG. 5 shows global frequencies distribution of chromosome 21 of the reference biological samples according to one working example of the present invention.

FIG. 6 shows a correspondence between the chromosome 22 global frequencies of the reference biological samples and the chromosome 21 43-45 Mb local frequencies of the reference biological samples.

FIG. 7 shows a correspondence between the chromosome 22 global frequencies of the reference biological samples and the chromosome 21 43-45 Mb global frequencies of the reference biological samples.

FIG. 8 shows a correspondence between the chromosome 22 global frequencies of the reference biological samples and the normalized chromosome 21 43-45 Mb global frequencies of the reference biological samples.

FIG. 9 is a flowchart of the step 130 of FIG. 1.

FIG. 10 shows reference standard scores distribution according to the working example shown in FIGS. 5-8.

FIG. 11 is a flowchart of the step 150 of FIG. 1.

FIG. 12 shows test and reference standard scores distribution according to the working example shown in FIGS. 5-8 and 10.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

The term “biological sample” as used herein refers to any biological sample that is taken from a subject (e.g., a human, such as a pregnant female) and contains one or more nucleic acid molecule(s) of interest.

The term “nucleic acid” refers to deoxyribonucleic acid (DNA), ribonucleic acid (RNA), or a polymer thereof in either single- or double-stranded form. Unless specifically limited, the term encompasses nucleic acids containing known analogs of natural nucleotides that have similar binding properties as the reference nucleic acid and are metabolized in a manner similar to naturally occurring nucleotides. Unless otherwise indicated, a particular nucleic acid sequence also implicitly encompasses conservatively modified variants thereof (e.g., degenerate codon substitutions), alleles, orthologs, single nucleotide polymorphisms (SNPs), and complementary sequences as well as the sequence explicitly indicated. The term nucleic acid is used interchangeably with gene, cDNA, mRNA, small noncoding RNA, micro RNA (miRNA), Piwi-interacting RNA, and short hairpin RNA (shRNA) encoded by a gene or locus.

The term “based on” as used herein means “based at least in part on” and refers to one value or result being used in the determination of another value or result, such as occurs in the relationship of an input of a method and the output of that method.

The term “chromosomal aneuploidy” as used herein means a variation in the quantitative number of a chromosome from that of a diploid genome. The variation may be a gain or a loss. It may involve the whole of one chromosome or a region of a chromosome.

The term “cutoff value” as used herein means a numerical value whose value is used to arbitrate between two or more states (e.g. abnormal and normal) of classification for a biological sample. For example, if a parameter is greater than the cutoff value, a first classification of the quantitative data is made (e.g. abnormal); or if the parameter is less than the cutoff value, a different classification of the quantitative data is made (e.g. normal).

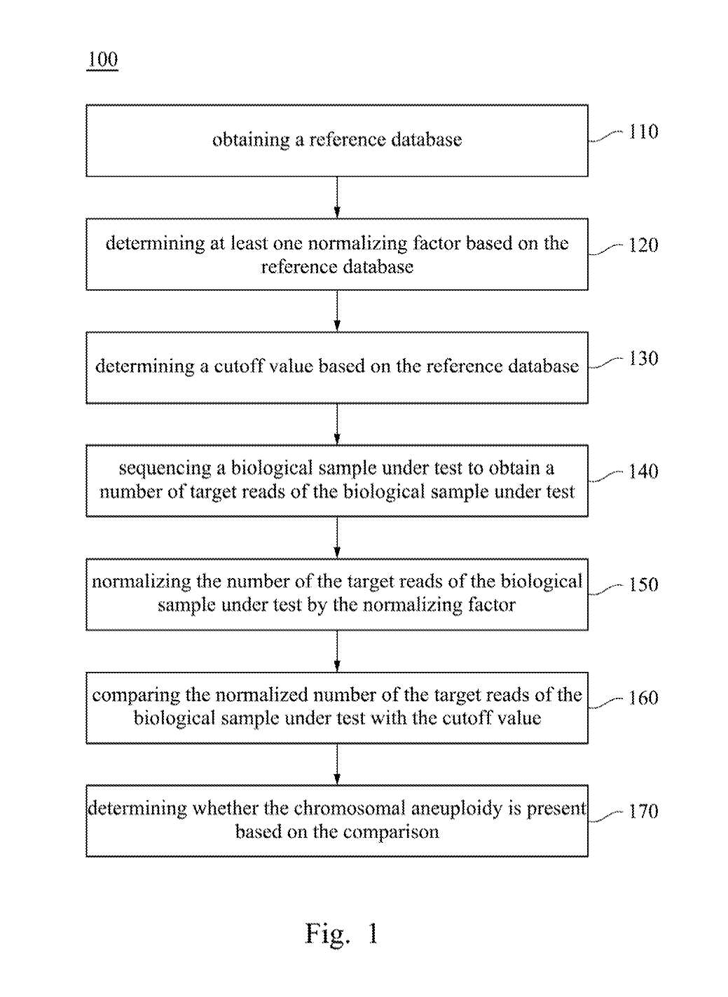

FIG. 1 is a flowchart of a method for detecting a chromosomal aneuploidy according to some embodiments of the present invention. As shown in FIG. 1, a method for detecting a chromosomal aneuploidy relating to a target nucleic acid region includes the following steps. In the step 110, a reference database is obtained. The reference database is established by sequencing a plurality of reference biological samples by a sequencing platform. The reference biological samples may be plasma, urine, serum, or any other suitable samples. The reference biological samples are respectively obtained from pregnant females. Therefore, each reference biological samples contains nucleic acid molecules from the pregnant female and a fetus thereof. The nucleic acid molecules may be, for example, fragments from chromosomes. The sequencing platform may be, for example, a next-generation sequencing platform, such as 454 platform (Roche), HiSeq, NextSeq, and MiSeq System (Illumina platform), Ion Torrent PGM and Proton System (Life Technologies), or Minion (Oxford Nanopore).

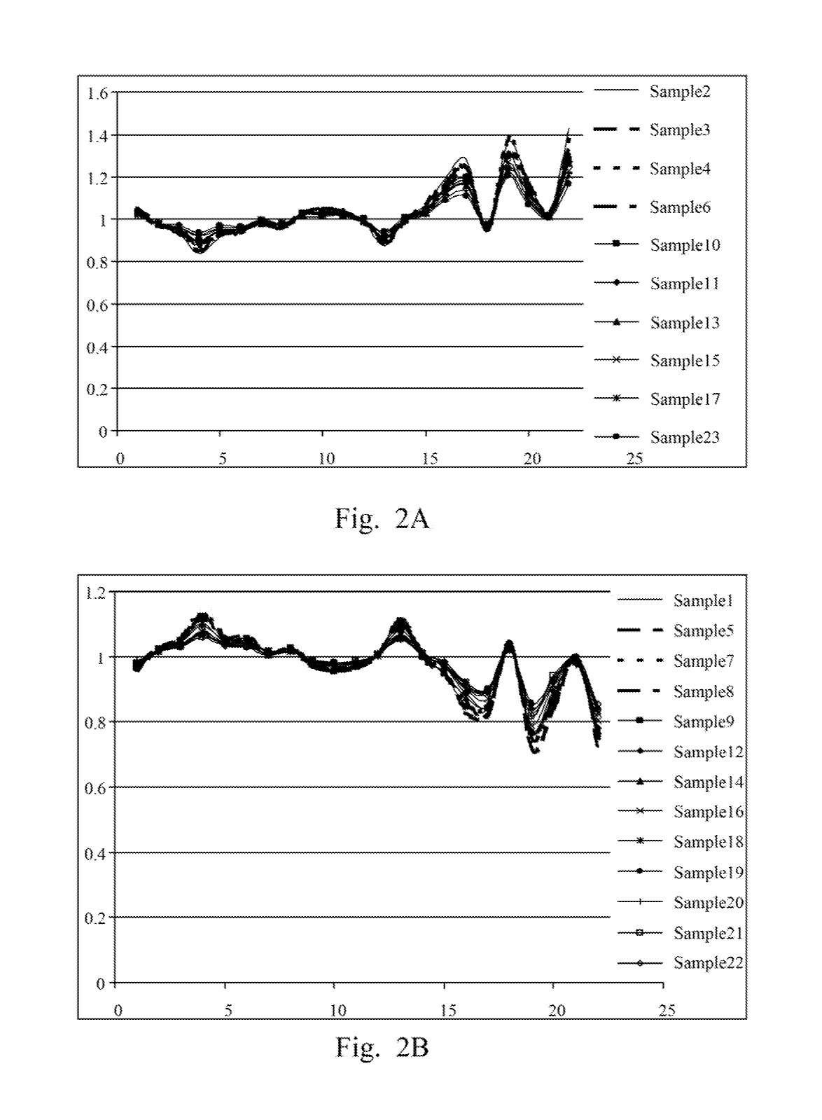

FIGS. 2A and 2B shows plots of chromosome reads of a plurality of reference biological samples sequenced by the same sequencing platform according to a plurality of working examples of the present invention. In FIGS. 2A and 2B, X axis is the chromosome number, and Y axis is the variation from the mean in a number of reads from each chromosome. As shown in FIGS. 2A and 2B, there is a fluctuation in the number of the reads from each chromosome. This fluctuation may be caused by sample properties, system properties, or environmental factors. Therefore, whether the chromosomal aneuploidy is present in the fetus cannot be determined based on only the number of the reads from each chromosome because of the fluctuation.

Reference is made to FIG. 1. In the step 120, at least one normalizing factor is determined based on the reference database. As shown in FIGS. 2A and 2B, the numbers of the reads from chromosomes correlate with each other. That is, an increase in the number of the reads from one chromosome would decrease the number of the reads from another chromosome. Since the reference biological samples of FIGS. 2A and 2B were obtained in substantially the same way and were sequenced by the same sequencing platform, the fluctuations for different reference biological samples are substantially the same. Therefore, the correlated chromosome may be used to normalize the chromosome of interest to eliminate the fluctuation.

Since a female fetus does not have chromosome Y, a biological sample from a female fetus would have a different chromosome reads profile when compared with that of a male fetus sample. Therefore, the reference database of the step 110 may be gender based. That is, if a biological sample under test is from a male fetus, a male fetus reference database is used. If the biological sample under test is from a female fetus, a female fetus reference database is used.

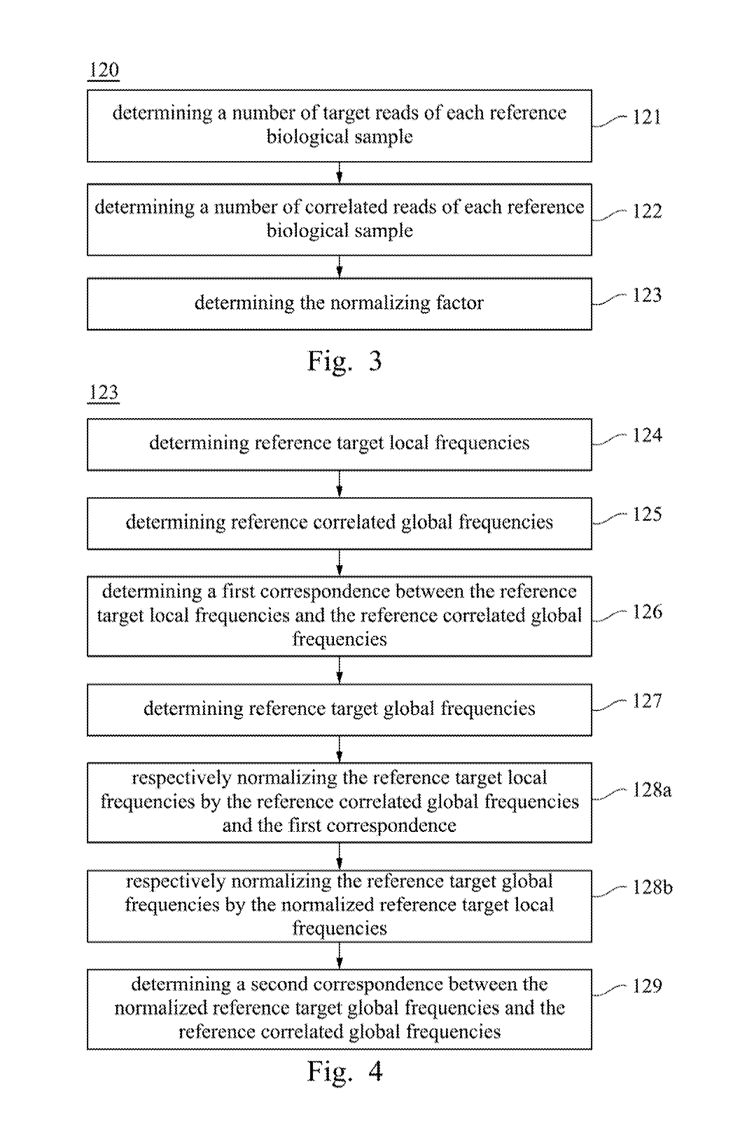

FIG. 3 is a flowchart of the step 120 of FIG. 1. The step 120 includes the following steps. In the step 121, a number of target reads of each reference biological sample is determined. The target reads of each reference biological sample originate from the target nucleic acid region. In the step 122, a number of correlated reads of each reference biological sample is determined. The numbers of the correlated reads of the reference biological samples correlate with the numbers of the target reads of the reference biological samples. For example, the numbers of the correlated reads of the reference biological samples may linearly correlate with the numbers of the target reads of the reference biological samples. The numbers of the correlated reads of the reference biological samples and the numbers of the target reads of the reference biological samples may have a correlation coefficient in a range from about 0.7 to about 0.99. The correlated reads of each reference biological sample originate from a correlated nucleic acid region. In the step 123, the normalizing factor is determined based on the numbers of the target reads of the reference biological samples and the numbers of the correlated reads of the reference biological samples.

FIG. 4 is a flowchart of the step 123 of FIG. 3. More specifically, the step 123 includes the following steps. In the step 124, reference target local frequencies are determined. Each reference target local frequency is a ratio of the number of the target reads of each reference biological sample to a number of local reads of said each reference biological sample. The local reads of each reference biological sample originate from the target nucleic acid region's own chromosome. In the step 125, reference correlated global frequencies are determined. Each reference correlated global frequency is a ratio of the number of the correlated reads of each reference biological sample to a number of total reads of said each reference biological sample. In the step 126, a first correspondence between the reference target local frequencies and the reference correlated global frequencies is determined. In the step 127, reference target global frequencies are determined. Each reference target global frequency is a ratio of the number of the target reads of each reference biological sample to the number of the total reads of said each reference biological sample. In the step 128a, the reference target local frequencies are respectively normalized by the reference correlated global frequencies and the first correspondence. In the step 128b, the reference target global frequencies are respectively normalized by the normalized reference target local frequencies. In the step 129, a second correspondence between the normalized reference target global frequencies and the reference correlated global frequencies is determined.

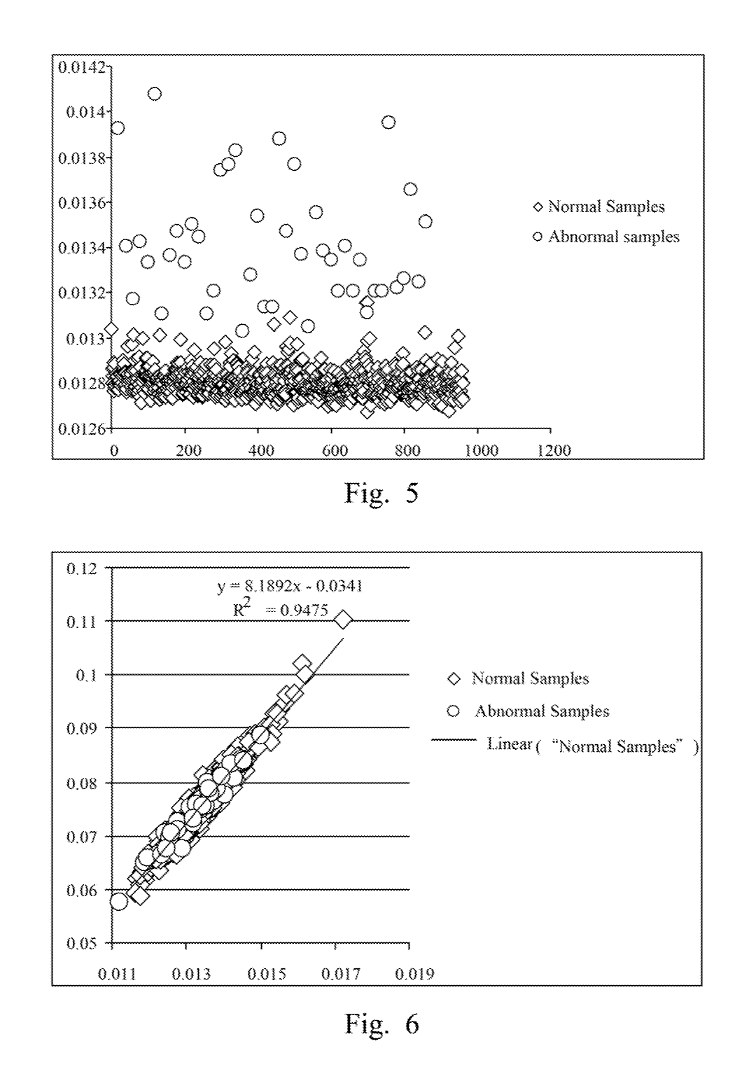

The following description will take male trisomy 21 detection as an example to illustrate how to perform the step 120. FIG. 5 shows global frequencies distribution of chromosome 21 for the reference biological samples according to one working example of the present invention. In FIG. 5, Y axis is the global frequency of chromosome 21. The global frequency of chromosome 21, r(21)/r(all), is a ratio of a number of reads of each reference biological sample originating from chromosome 21, r(21), to a number of total reads of said each reference biological sample, r(all). As shown in FIG. 5, some abnormal samples are mixed with normal samples, and therefore a cutoff value cannot be determined. In this working example of the present invention, the reference biological samples are 1004 in number, and the reference biological samples are plasma obtained from pregnant females. The sequencing platform is Illumina HiSeq.

In this working example of the present invention, chromosome 21 43-45 Mb region was selected to be the target nucleic acid region. After inspection, it was found that numbers of reads of the reference biological samples originating from chromosome 22 and numbers of reads of the reference biological samples originating from chromosome 21 43-45 Mb region have a correlation coefficient of 0.94. Therefore, chromosome 22 was selected to be the correlated nucleic acid region. According to the step 124, chromosome 21 43-45 Mb local frequencies of the reference biological samples were determined. The chromosome 21 43-45 Mb local frequency of each reference biological sample is a ratio of the number of the reads of said each reference biological sample originating from chromosome 21 43-45 Mb region to a number of reads of said each reference biological sample originating from chromosome 21. According to the step 125, chromosome 22 global frequencies of the reference biological samples were determined. The chromosome 22 global frequency of each reference biological sample is a ratio of the number of the reads of said each reference biological sample originating from chromosome 22 to a number of total reads of said each reference biological sample.

FIG. 6 shows a correspondence between the chromosome 22 global frequencies of the reference biological samples and the chromosome 21 43-45 Mb local frequencies of the reference biological samples. In FIG. 6, X axis is the chromosome 22 global frequency, and Y axis is the chromosome 21 43-45 Mb local frequency. It was observed that there is a linear relationship between the chromosome 22 global frequencies of the reference biological samples which are normal and the chromosome 21 43-45 Mb local frequencies of the reference biological samples which are normal. The chromosome 22 global frequencies of the reference biological samples which are normal and the chromosome 21 43-45 Mb local frequencies of the reference biological samples which are normal have a coefficient of determination of 0.9475 and a regression line (Y=8.1892X−0.0341). The regression line (Y=8.1892X−0.0341) can be considered the first correspondence of the step 126.

According to the step 127, chromosome 21 43-45 Mb global frequencies of the reference biological samples were determined. The chromosome 21 43-45 Mb global frequency of each reference biological sample is a ratio of the number of the reads of said each reference biological sample originating from chromosome 21 43-45 Mb region to the number of the total reads of said each reference biological sample.

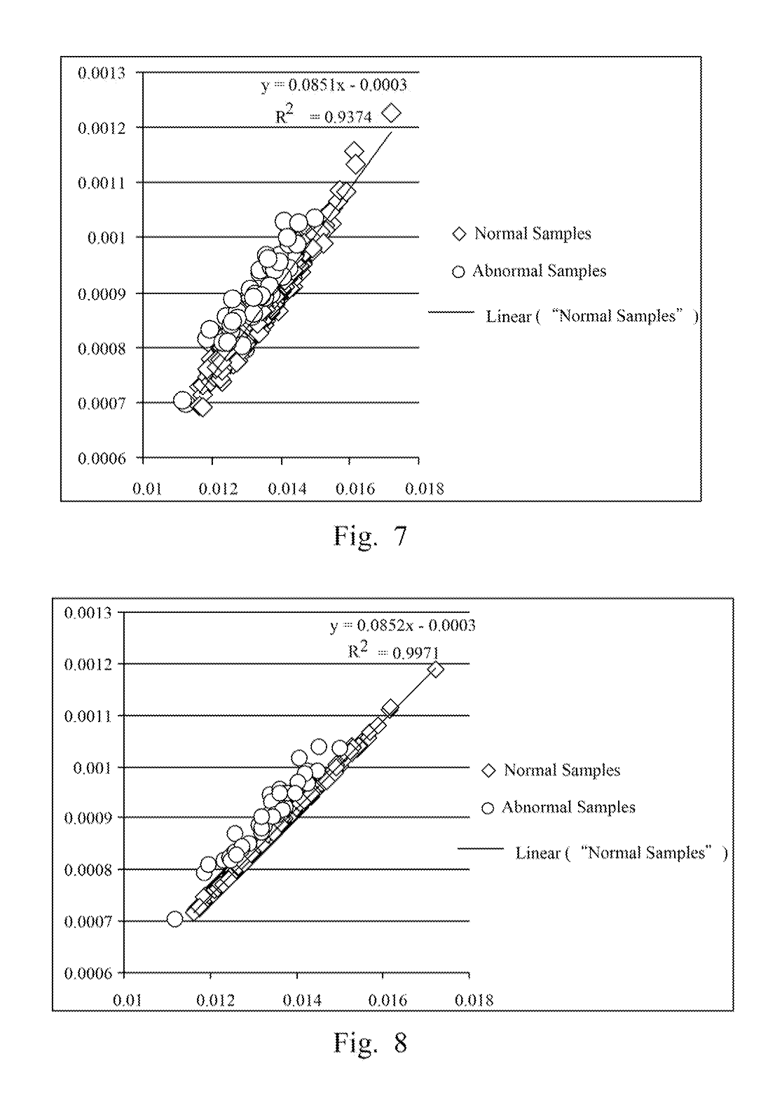

FIG. 7 shows a correspondence between the chromosome 22 global frequencies of the reference biological samples and the chromosome 21 43-45 Mb global frequencies of the reference biological samples. In FIG. 7, X axis is the chromosome 22 global frequency, and Y axis is the chromosome 21 43-45 Mb global frequency. It was observed that there is a linear relationship between the chromosome 22 global frequencies of the reference biological samples which are normal and the chromosome 21 43-45 Mb global frequencies of the reference biological samples which are normal. The chromosome 22 global frequencies of the reference biological samples which are normal and the chromosome 21 43-45 Mb global frequencies of the reference biological samples which are normal have a coefficient of determination of 0.9374 and a regression line (Y=0.0851X−0.0003).

According to the step 128a, the chromosome 21 43-45 Mb local frequencies of the reference biological samples were respectively normalized by the chromosome 22 global frequencies of the reference biological samples and the first correspondence. According to the step 128b, the chromosome 21 43-45 Mb global frequencies of the reference biological samples were respectively normalized by the normalized chromosome 21 43-45 Mb local frequencies of the reference biological samples. Specifically, the normalized chromosome 21 43-45 Mb global frequency of each reference biological sample was calculated by the following formula I:

y1=x3/(x2/(8.1892*x1−0.0341)) formula I

, where y1 is the normalized chromosome 21 43-45 Mb global frequency of each reference biological sample, x1 is the chromosome 22 global frequency of said each reference biological sample, x2 is the chromosome 21 43-45 Mb local frequency of said each reference biological sample, and x3 is the chromosome 21 43-45 Mb global frequency of said each reference biological sample.

FIG. 8 shows a correspondence between the chromosome 22 global frequencies of the reference biological samples and the normalized chromosome 21 43-45 Mb global frequencies of the reference biological samples. In FIG. 8, X axis is the chromosome 22 global frequency, and Y axis is the normalized chromosome 21 43-45 Mb global frequency. It was observed that there is a linear relationship between the chromosome 22 global frequencies of the reference biological samples which are normal and the normalized chromosome 21 43-45 Mb global frequencies of the reference biological samples which are normal. The chromosome 22 global frequencies of the reference biological samples which are normal and the normalized chromosome 21 43−45 Mb global frequencies of the reference biological samples which are normal have a coefficient of determination of 0.9971 and a regression line (Y=0.0852X−0.0003). The regression line (Y=0.0852X−0.0003) can be considered the second correspondence of the step 129.

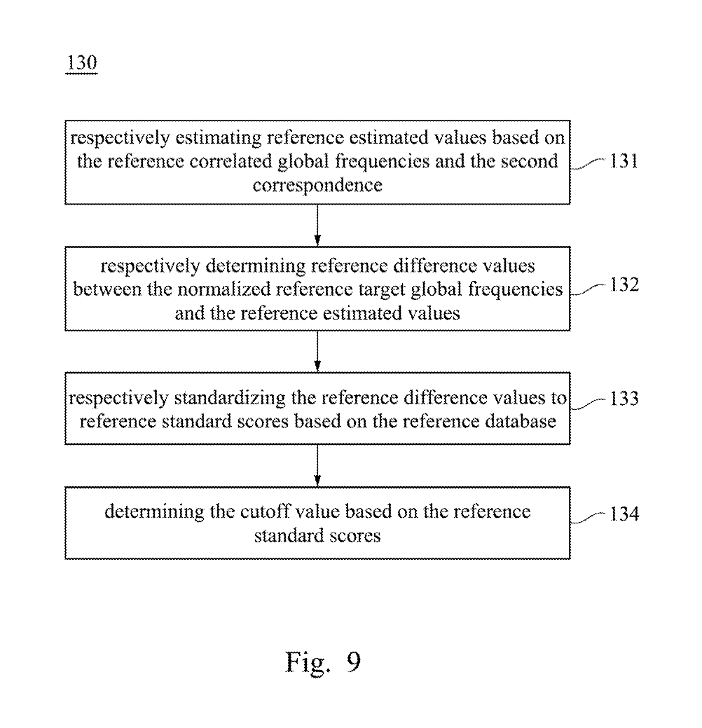

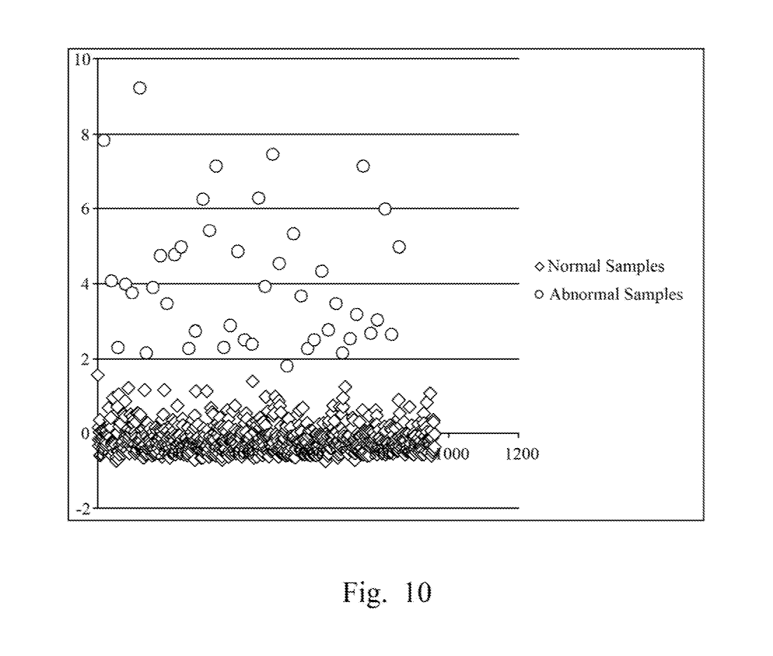

Reference is made to FIG. 1. In the step 130, a cutoff value is determined based on the reference database. FIG. 9 is a flowchart of the step 130 of FIG. 1. In the step 131, reference estimated values are respectively estimated based on the reference correlated global frequencies and the second correspondence. In the step 132, reference difference values between the normalized reference target global frequencies and the reference estimated values are respectively determined. In the step 133, the reference difference values are respectively standardized to reference standard scores based on the reference database. In the step 134, the cutoff value is determined based on the reference standard scores.

The following description will continue the male trisomy 21 detection shown in FIGS. 5-8 to illustrate how to perform the step 130. In this working example, according to the step 131, reference estimated values were respectively estimated based on the chromosome 22 global frequencies of the reference biological samples and the second correspondence. According to the step 132, reference difference values were determined. Each reference difference value is between the normalized chromosome 21 43-45 Mb global frequency of each reference biological sample and the corresponding reference estimated value. Specifically, each reference difference value was calculated by the following formula II:

y2=y1−(0.0852*x1−0.0003) formula II

, where y1 is the normalized chromosome 21 43-45 Mb global ratio of each reference biological sample, y2 is the reference difference value, and x1 is the chromosome 22 global frequency of said each reference biological sample.

According to the step 133, the reference difference values were respectively standardized to reference standard scores. Specifically, each reference standard score was calculated by the following formula III:

Z=y2−0.000028/0.0000094 formula III

, where Z is the reference standard score, y2 is the reference difference value, 0.000028 is the average of the reference difference values, and 0.0000094 is the standard deviation of the reference difference values.

FIG. 10 shows reference standard scores distribution according to the working example shown in FIGS. 5-8. In FIG. 10, Y axis is the standard score. As shown in FIG. 10, the abnormal samples are separated from the normal samples, and therefore a cutoff value could be determined accordingly. In the present working example, the cutoff value was determined to be 1.75.

Reference is made to FIG. 1. In the step 140, a biological sample under test is sequenced by the sequencing platform to obtain a number of target reads of the biological sample under test. The biological sample under test may be plasma, urine, serum, or any other suitable samples. The biological sample under test is obtained from a pregnant female and has nucleic acid molecules from the pregnant female and a fetus thereof. The nucleic acid molecules may be, for example, fragments from chromosomes. The target reads of the biological sample under test originate from the target nucleic acid region

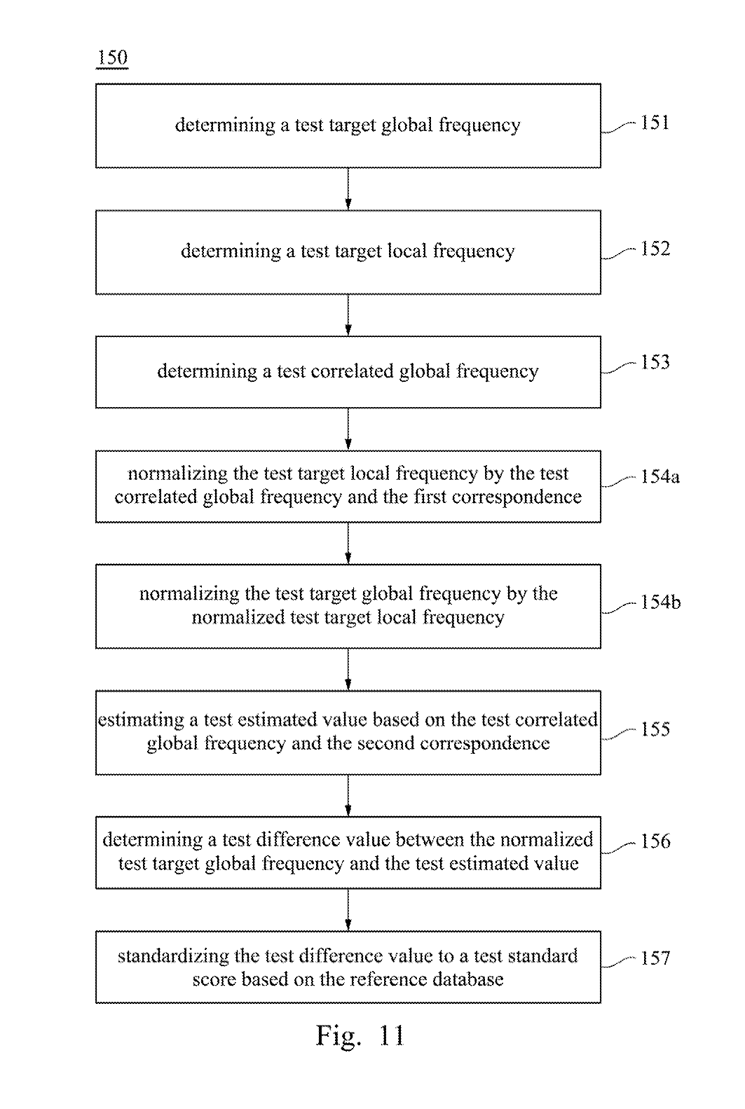

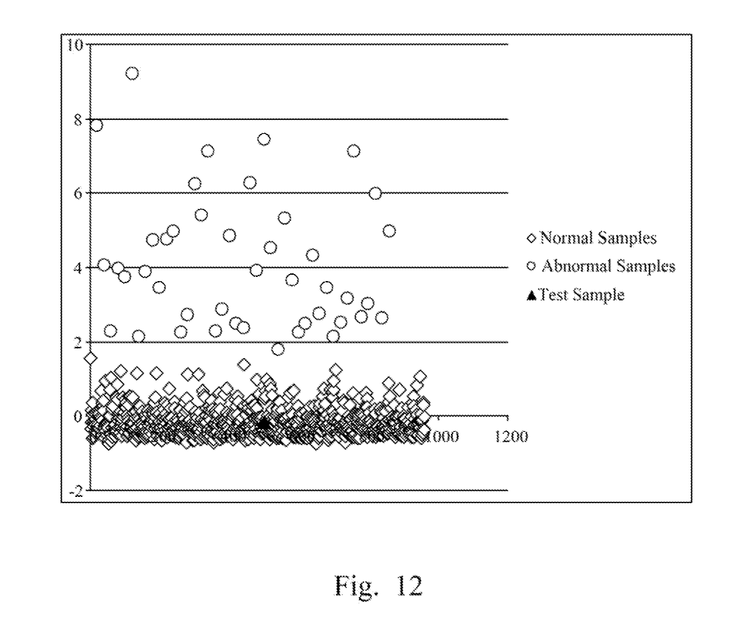

In the step 150, the number of the target reads of the biological sample under test is normalized by the normalizing factor. FIG. 11 is a flowchart of the step 150 of FIG. 1. In the step 151, a test target global frequency is determined. The test target global frequency is a ratio of the number of the target reads of the biological sample under test to a number of total reads of the biological sample under test. In the step 152, a test target local frequency is determined. The test target local frequency is a ratio of the number of the target reads of the biological sample under test to a number of local reads of the biological sample under test. The local reads of the biological sample under test originate from the target nucleic acid region's own chromosome. In the step 153, a test correlated global frequency is determined. The test correlated global frequency is a ratio of a number of correlated reads of the biological sample under test to the number of the total reads of the biological sample under test. The correlated reads of the biological sample under test originate from the correlated nucleic acid region. In the step 154a, the test target local frequency is normalized by the test correlated global frequency and the first correspondence. In the step 154b, the test target global frequency is normalized by the normalized test target local frequency.

In the step 155, a test estimated value is estimated based on the test correlated global frequency and the second correspondence. In the step 156, a test difference value between the normalized test target global frequency and the test estimated value is determined. In the step 157, the test difference value is standardized to a test standard score based on the reference database.

Reference is made to FIG. 1. In the step 160, the normalized number of the target reads of the biological sample under test is compared with the cutoff value. In the step 170, whether the chromosomal aneuploidy relating to the target nucleic acid region is present in the fetus is determined based on the comparison. Specifically, in the step 160, the test standard score calculated by the step 157 is compared with the cutoff value determined by the step 130. Then, in the step 170, if the test standard score calculated by the step 157 is greater than the cutoff value determined by the step 130, the chromosomal aneuploidy relating to the target nucleic acid region is determined to be present in the fetus, i.e. abnormal. If the test standard score calculated by the step 157 is less than the cutoff value determined by the step 130, the chromosomal aneuploidy relating to the target nucleic acid region is determined to be absent in the fetus, i.e. normal.

The following description will continue the male trisomy 21 detection shown in FIGS. 5-8 and 10 to illustrate how to perform the steps 140-170. According to the step 140, a biological sample under test (plasma) was obtained from a pregnant female. Then, the biological sample under test was sequenced by Illumina HiSeq.

According to the step 151, a chromosome 21 43-45 Mb global frequency of the biological sample under test was determined. The chromosome 21 43-45 Mb global frequency of the biological sample under test is a ratio of a number of reads of the biological sample under test originating from chromosome 21 43-45 Mb region to a number of total reads of the biological sample under test. According to the step 152, a chromosome 21 43-45 Mb local frequency of the biological sample under test was determined. The chromosome 21 43-45 Mb local frequency of the biological sample under test is a ratio of the number of the reads of the biological sample under test originating from chromosome 21 43-45 Mb region to a number of reads of the biological sample under test originating from chromosome 21. According to the step 153, a chromosome 22 global frequency of the biological sample under test was determined. The chromosome 22 global frequency of the biological sample under test is a ratio of a number of reads of the biological sample under test originating from chromosome 22 to the number of the total reads of the biological sample under test.

According to the step 154a, the chromosome 21 43-45 Mb local frequency of the biological sample under test was normalized by the chromosome 22 global frequency of the biological sample under test and the first correspondence. In the step 154b, the chromosome 21 43-45 Mb global frequency of the biological sample under test was normalized by the normalized chromosome 21 43-45 Mb local frequency of the biological sample under test. Specifically, the normalized chromosome 21 43-45 Mb global frequency of the biological sample under test was calculated by the following formula IV:

y1=x3/(x2/(8.1892*x1−0.0341)) formula IV

, where y1 is the normalized chromosome 21 43-45 Mb global frequency of the biological sample under test, x1 is the chromosome 22 global frequency of the biological sample under test, x2 is the chromosome 21 43-45 Mb local frequency of the biological sample under test, and x3 is the chromosome 21 43-45 Mb global frequency of the biological sample under test.

According to the step 155, a test estimated value was estimated based on the chromosome 22 global frequency of the biological sample under test and the second correspondence. According to the step 156, a test difference value between the normalized chromosome 21 43-45 Mb global frequency of the biological sample under test and the test estimated value was determined. Specifically, the test difference value was calculated by the following formula V:

y2=y1−(0.0852*x1−0.0003) formula IV

, where y1 is the normalized chromosome 21 43-45 Mb global frequency of the biological sample under test, y2 is the test difference value, x1 is the chromosome 22 global frequency of the biological sample under test.

According to the step 157, the test difference value was standardized to a test standard score based on the reference database. Specifically, the test standard score was calculated by the following formula VI:

Z=y2−0.000028/0.0000094 formula VI

, where Z is the test standard score, y2 is the test difference value, 0.000028 is the average of the reference difference values, and 0.0000094 is the standard deviation of the reference difference values.

FIG. 12 shows test and reference standard scores distribution according to the working example shown in FIGS. 5-8 and 10. In FIG. 12, Y axis is the standard score. As shown in FIG. 12, the test standard score is −0.16, which is less than the cutoff value, i.e. 1.75. Therefore, the biological sample under test was determined to be normal. That is, trisomy 21 was determined to be absent in the fetus.

In some embodiments, the method described above is implemented as a program stored in a non-transitory machine readable medium. When the program is executed by at least one processing unit, the method described above is performed. The non-transitory machine readable medium may include, but is not limited to, floppy disks, optical disks, compact discs (CDs), digital video discs (DVDs), magneto-optical disks, read-only memories (ROMs), random-access memories (RAMs), erasable programmable read only memories (EPROMs), electrically erasable programmable read-only memories (EEPROMs), magnetic or optical cards, or any type of media/machine readable medium suitable for storing instructions.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for detecting a chromosomal aneuploidy relating to a target nucleic acid region, the method comprising:
obtaining a reference database, wherein the reference database is established by sequencing a plurality of reference biological samples by a sequencing platform;
determining at least one normalizing factor based on the reference database;
determining a cutoff value based on the reference database;
sequencing a biological sample under test by the sequencing platform to obtain a number of target reads of the biological sample under test, wherein the biological sample under test is obtained from a pregnant female and has nucleic acid molecules from the pregnant female and a fetus thereof, and the target reads of the biological sample under test originate from the target nucleic acid region;
normalizing the number of the target reads of the biological sample under test by the normalizing factor;
comparing the normalized number of the target reads of the biological sample under test with the cutoff value; and
determining whether the chromosomal aneuploidy relating to the target nucleic acid region is present in the fetus based on the comparison.

2. The method of claim 1, wherein the reference database is gender based.

3. The method of claim 1, wherein the determining the normalizing factor comprises:
determining a number of target reads of each reference biological sample, wherein the target reads of each reference biological sample originate from the target nucleic acid region;
determining a number of correlated reads of each reference biological sample, wherein the numbers of the correlated reads of the reference biological samples correlate with the numbers of the target reads of the reference biological samples, and the correlated reads of each reference biological sample originate from a correlated nucleic acid region; and
determining the normalizing factor based on the numbers of the target reads of the reference biological samples and the numbers of the correlated reads of the reference biological samples.

4. The method of claim 3, wherein the numbers of the correlated reads of the reference biological samples linearly correlate with the numbers of the target reads of the reference biological samples.

5. The method of claim 3, wherein the numbers of the correlated reads of the reference biological samples and the numbers of the target reads of the reference biological samples have a correlation coefficient in a range from about 0.7 to about 0.99.

6. The method of claim 3, wherein the determining the normalizing factor based on the numbers of the target reads of the reference biological samples and the numbers of the correlated reads of the reference biological samples comprises:
determining reference target local frequencies, wherein each reference target local frequency is a ratio of the number of the target reads of each reference biological sample to a number of local reads of said each reference biological sample, and the local reads of each reference biological sample originate from the target nucleic acid region's own chromosome;
determining reference correlated global frequencies, wherein each reference correlated global frequency is a ratio of the number of the correlated reads of each reference biological sample to a number of total reads of said each reference biological sample; and
determining a first correspondence between the reference target local frequencies and the reference correlated global frequencies.

7. The method of claim 6, wherein the normalizing the number of the target reads of the biological sample under test comprises:
determining a test target global frequency, wherein the test target global frequency is a ratio of the number of the target reads of the biological sample under test to a number of total reads of the biological sample under test;
determining a test target local frequency, wherein the test target local frequency is a ratio of the number of the target reads of the biological sample under test to a number of local reads of the biological sample under test, and the local reads of the biological sample under test originate from the target nucleic acid region's own chromosome;
determining a test correlated global frequency, wherein the test correlated global frequency is a ratio of a number of correlated reads of the biological sample under test to the number of the total reads of the biological sample under test, and the correlated reads of the biological sample under test originate from the correlated nucleic acid region;
normalizing the test target local frequency by the test correlated global frequency and the first correspondence; and
normalizing the test target global frequency by the normalized test target local frequency.

8. The method of claim 7, wherein the determining the normalizing factor based on the numbers of the target reads of the reference biological samples and the numbers of the correlated reads of the reference biological samples comprises:
determining reference target global frequencies, wherein each reference target global frequency is a ratio of the number of the target reads of each reference biological sample to the number of the total reads of said each reference biological sample;
respectively normalizing the reference target local frequencies by the reference correlated global frequencies and the first correspondence;
respectively normalizing the reference target global frequencies by the normalized reference target local frequencies; and
determining a second correspondence between the normalized reference target global frequencies and the reference correlated global frequencies.

9. The method of claim 8, wherein the determining the cutoff value comprises:
respectively estimating reference estimated values based on the reference correlated global frequencies and the second correspondence;
respectively determining reference difference values between the normalized reference target global frequencies and the reference estimated values;
respectively standardizing the reference difference values to reference standard scores based on the reference database; and
determining the cutoff value based on the reference standard scores.

10. The method of claim 9, wherein the normalizing the number of the target reads of the biological sample under test comprises:
estimating a test estimated value based on the test correlated global frequency and the second correspondence;
determining a test difference value between the normalized test target global frequency and the test estimated value; and
standardizing the test difference value to a test standard score based on the reference database;
wherein the comparing comprises:
comparing the test standard score with the cutoff value.

11. A non-transitory machine readable medium storing a program which, when executed by at least one processing unit, detects a chromosomal aneuploidy relating to a target nucleic acid region, the program comprising sets of instructions for:
obtaining a reference database, wherein the reference database is established by sequencing a plurality of reference biological samples by a sequencing platform;
determining at least one normalizing factor based on the reference database;
determining a cutoff value based on the reference database;
sequencing a biological sample under test by the sequencing platform to obtain a number of target reads of the biological sample under test, wherein the biological sample under test is obtained from a pregnant female and has nucleic acid molecules from the pregnant female and a fetus thereof, and the target reads of the biological sample under test originate from the target nucleic acid region;
normalizing the number of the target reads of the biological sample under test by the normalizing factor;
comparing the normalized number of the target reads of the biological sample under test with the cutoff value; and
determining whether the chromosomal aneuploidy relating to the target nucleic acid region is present in the fetus based on the comparison.

12. The non-transitory machine readable medium of claim 11, wherein the reference database is gender based.

13. The non-transitory machine readable medium of claim 11, wherein the set of instructions for determining the normalizing factor comprises sets of instructions for:
determining a number of target reads of each reference biological sample, wherein the target reads of each reference biological sample originate from the target nucleic acid region;
determining a number of correlated reads of each reference biological sample, wherein the numbers of the correlated reads of the reference biological samples correlate with the numbers of the target reads of the reference biological samples, and the correlated reads of each reference biological sample originate from a correlated nucleic acid region; and
determining the normalizing factor based on the numbers of the target reads of the reference biological samples and the numbers of the correlated reads of the reference biological samples.

14. The non-transitory machine readable medium of claim 13, wherein the numbers of the correlated reads of the reference biological samples linearly correlate with the numbers of the target reads of the reference biological samples.

15. The non-transitory machine readable medium of claim 13, wherein the numbers of the correlated reads of the reference biological samples and the numbers of the target reads of the reference biological samples have a correlation coefficient in a range from about 0.7 to about 0.99.

16. The non-transitory machine readable medium of claim 13, wherein the set of instructions for determining the normalizing factor based on the numbers of the target reads of the reference biological samples and the numbers of the correlated reads of the reference biological samples comprises sets of instructions for:
determining reference target local frequencies, wherein each reference target local frequency is a ratio of the number of the target reads of each reference biological sample to a number of local reads of said each reference biological sample, and the local reads of each reference biological sample originate from the target nucleic acid region's own chromosome;
determining reference correlated global frequencies, wherein each reference correlated global frequency is a ratio of the number of the correlated reads of each reference biological sample to a number of total reads of said each reference biological sample; and
determining a first correspondence between the reference target local frequencies and the reference correlated global frequencies.

17. The non-transitory machine readable medium of claim 16, wherein the set of instructions for normalizing the number of the target reads of the biological sample under test comprises sets of instructions for:
determining a test target global frequency, wherein the test target global frequency is a ratio of the number of the target reads of the biological sample under test to a number of total reads of the biological sample under test;
determining a test target local frequency, wherein the test target local frequency is a ratio of the number of the target reads of the biological sample under test to a number of local reads of the biological sample under test, and the local reads of the biological sample under test originate from the target nucleic acid region's own chromosome;
determining a test correlated global frequency, wherein the test correlated global frequency is a ratio of a number of correlated reads of the biological sample under test to the number of the total reads of the biological sample under test, and the correlated reads of the biological sample under test originate from the correlated nucleic acid region;
normalizing the test target local frequency by the test correlated global frequency and the first correspondence; and
normalizing the test target global frequency by the normalized test target local frequency.

18. The non-transitory machine readable medium of claim 17, wherein the set of instructions for determining the normalizing factor based on the numbers of the target reads of the reference biological samples and the numbers of the correlated reads of the reference biological samples comprises sets of instructions for:
determining reference target global frequencies, wherein each reference target global frequency is a ratio of the number of the target reads of each reference biological sample to the number of the total reads of said each reference biological sample;
respectively normalizing the reference target local frequencies by the reference correlated global frequencies and the first correspondence;
respectively normalizing the reference target global frequencies by the normalized reference target local frequencies; and
determining a second correspondence between the normalized reference target global frequencies and the reference correlated global frequencies.

19. The non-transitory machine readable medium of claim 18, wherein the set of instructions for determining the cutoff value comprises sets of instructions for:
respectively estimating reference estimated values based on the reference correlated global frequencies and the second correspondence;
respectively determining reference difference values between the normalized reference target global frequencies and the reference estimated values;
respectively standardizing the reference difference values to reference standard scores based on the reference database; and
determining the cutoff value based on the reference standard scores.

20. The non-transitory machine readable medium of claim 19, wherein the set of instructions for normalizing the number of the target reads of the biological sample under test comprises sets of instructions for:
estimating a test estimated value based on the test correlated global frequency and the second correspondence;
determining a test difference value between the normalized test target global frequency and the test estimated value; and
standardizing the test difference value to a test standard score based on the reference database;
wherein the set of instructions for comparing comprises a set of instructions for:
comparing the test standard score with the cutoff value.
